(19) United States
(12) Patent Application Publication
(10) Pub. No.: US 2008/0276170 A1
(43) Pub. Date: Nov. 6, 2008

(54) SYSTEM AND METHOD FOR GENERATING AND ARRANGING STATUS GADGETS IN A SMALL DISPLAY AREA

(75) Inventors: Michel Bonansea, San Francisco, CA (US); Robert Murphy, San Anselmo, CA (US); Sara Berg, Mt. View, CA (US); Elizabeth Dykstra-Erickson, San Francisco, CA (US)

Correspondence Address: BERRY & ASSOCIATES P.C., 9255 SUNSET BOULEVARD, SUITE 810, LOS ANGELES, CA, 90069, US

(73) Assignee: ACCESS SYSTEMS AMERICAS, INC., Sunnyvale, CA (US)

(21) Appl. No.: 12/025,758

(22) Filed: Feb. 5, 2008

Related U.S. Application Data
(60) Provisional application No. 60/888,536, filed on Feb. 6, 2007.

(51) Int. Cl. G06F 3/048

(52) U.S. Cl. 715/708

(57) ABSTRACT

A system and method for persistently providing at least one status notification regarding a device component or application on an electronic system or device is provided. A selectable status notification icon (status gadget) is assigned for each of a number of applications and/or components for which status is monitored, each status notification icon reflecting changes in the monitored status. The status gadgets are persistently displayed in a user interface on the display screen of the electronic system or device. A contextual dialog is also displayed when a status gadget is selected.

### PRIORITY CLAIM

The present invention claims the benefit under 35 U.S.C. §119(e) of U.S. Provisional Patent Application No. 60/888,536 filed on Feb. 6, 2007 and entitled “Method for Displaying Status Gadgets on a Mobile Device”, the contents of which are incorporated herein by reference and are relied upon here.

### BACKGROUND OF THE INVENTION

1. Field of the Invention

The present invention relates to a system and method for persistently displaying various status notifications to users of electronic systems and devices such as mobile devices and information appliances, and more particularly, to a system and method for displaying status notifications on an electronic system or device having a relatively small display screen.

2. Introduction

Current models of cell phones, personal digital assistants (PDAs), and numerous other information appliances (e.g., MP3 players, thin clients, gaming stations) and electronic devices typically have many the processing capabilities of a desk top computer, but often have a smaller display area in which to present information. Alternatively, an electronic device having a large display space may allocate only a small portion or window to a particular application or set of applications (e.g., a television displaying a web browser window in a portion of the viewing screen), with the same result, namely, that a large amount of information is presented to a user in a small display area.

Such electronic devices often display state information persistently to enable the user to grasp this information quickly upon a view of the display screen. This information is typically arranged to occupy a small portion of the display screen to allow space for applications. For example, the state information may be displayed as small icons that may change in appearance to reflect a change in state. Example state information includes such information as: cell phone signal strength, battery level, whether the device is being charged, whether voice mail messages are waiting, memory space available, current time, etc. The icons may be interactive and allow users to convenient activate an application, component or utility.

There amount of status information (e.g., the number of corresponding icons) may too large to be displayed clearly in a relatively small display area. Conventional arrangements of status information on electronic devices such as status bars and task bars generally do not provide interactivity with the status information.

There is therefore a need for a system and method for displaying and interacting with status information on electronic devices having relatively small display areas.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

In a first aspect, the present invention provides a method for persistently providing at least one status notification regarding a device component or application on an electronic device having a display screen. The method includes steps of: (1) assigning a selectable status notification icon for each of the at least one status notification, each status notification icon reflecting changes in the status notification for which it is assigned; (2) persistently displaying the status notification icon for each of the at least one status notification on the display screen of the electronic device; and (3) displaying a contextual dialog when a status notification icon is selection by a user of the electronic device.

In a second aspect, the present invention provides an electronic system that comprises a display screen, and a processor that is adapted to: (1) generate a user interface on the display screen; (2) execute a plurality of applications; (3) display a set of status gadget notification icons on the user interface, each icon presenting a status of one of the plurality of applications; and (4) display a contextual dialog on the user interface upon selection of one of the status gadget notification icons by the user.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. The present invention will be described and explained with additional specificity and detail through the use of the following drawings.

FIG. 1 is a block diagram of an exemplary electronic device in which the various aspects of the present invention may be practiced.

FIG. 2 is an illustration of an exemplary user interface including a status gadget holder and status gadgets in accordance with an embodiment of the present invention.

FIG. 3 is a block diagram of an exemplary system for generating and managing a user interface including a status gadget holder and status gadgets according to an embodiment of the present invention.

FIG. 4 is an illustration of an alternative user interface having a status gadget holder and status gadgets in a different orientation with respect to the embodiment shown in FIG. 2.

FIG. 5 is an illustration of an exemplary user interface including a status gadget holder and status gadgets in accordance with an embodiment of the present invention.

### DETAILED DESCRIPTION OF THE INVENTION

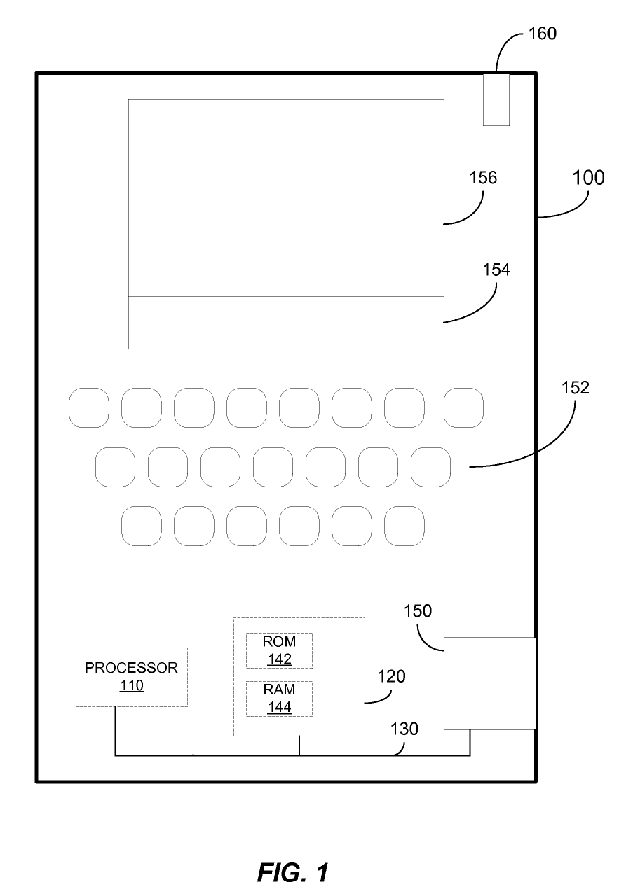

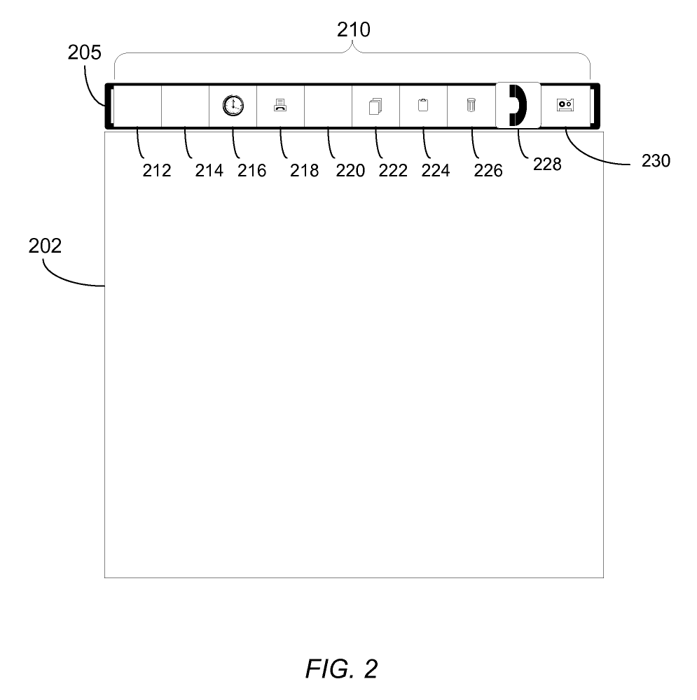

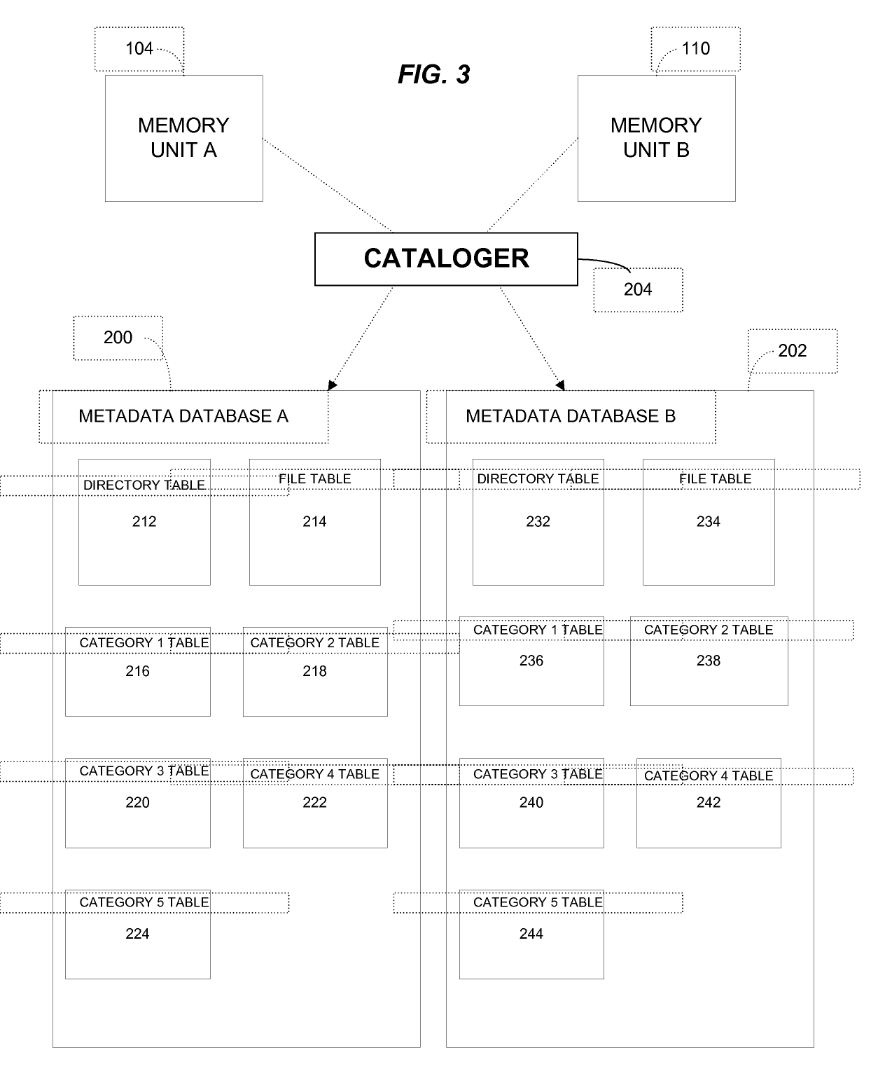

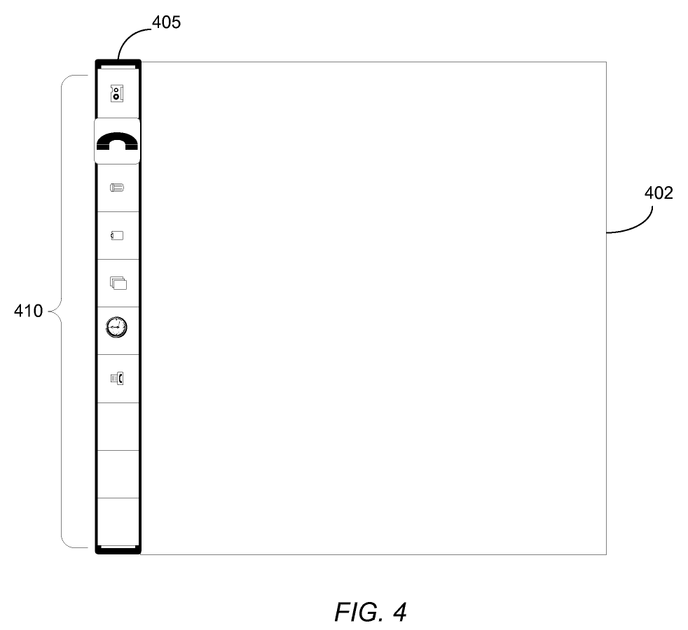

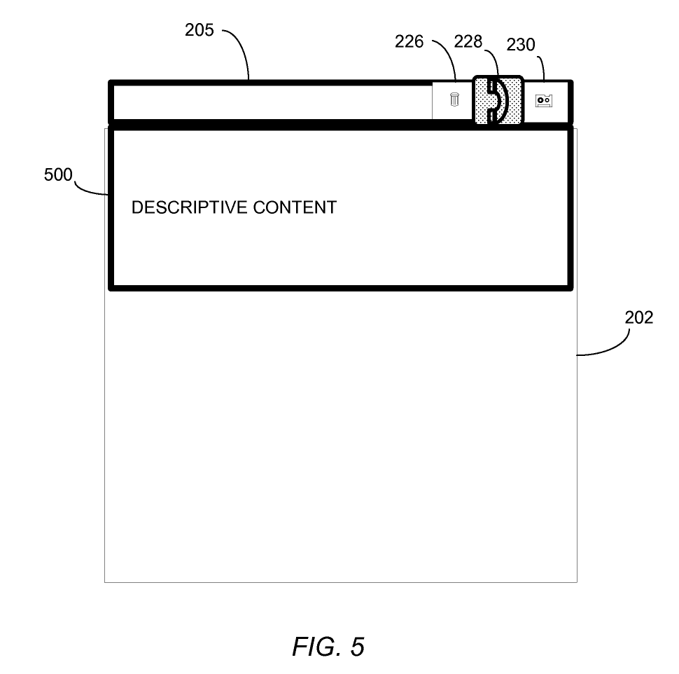

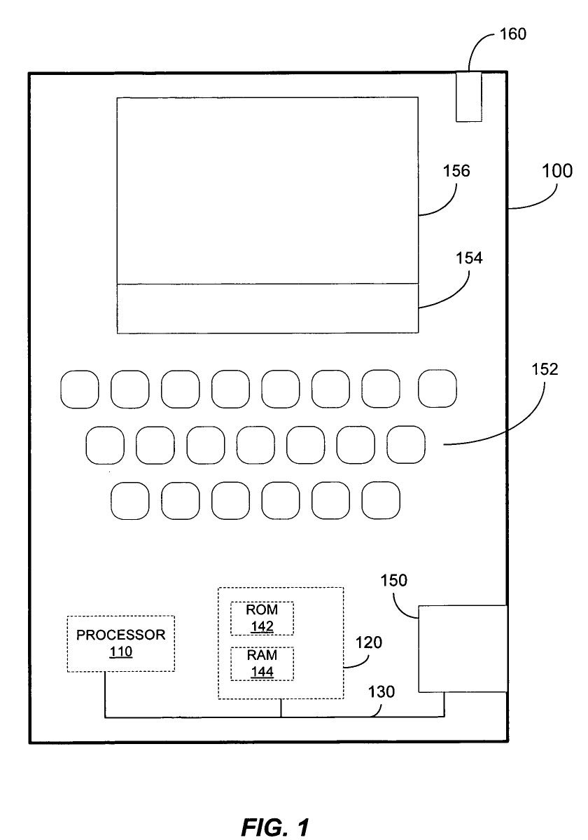

FIG. 1 is a block diagram of an exemplary electronic device 100 that implements the systems and methods according to an embodiment the present invention. While the embodiment of FIG. 1 takes the form of a mobile electronic (e.g. a personal digital assistant (PDA) such as the Palm® series of handheld devices), it is emphasized that the present invention applies to electronic systems and devices in general and particularly to electronic systems and devices that include relatively small display screens or which allocate a restricted portion of a larger display screen to a particular application or set of applications (e.g., a television that displays a web browser window in a portion of the viewing screen).

With continued reference to FIG. 1, an exemplary electronic device 100 includes a processing unit 110. An internal memory 120 and various other system components are coupled to the processor 110 by a system bus 130. The system bus 130 may be any of several types of bus structures including a memory bus or memory controller, a peripheral bus, or a local bus using any of a variety of bus architectures. The internal memory 120 includes read only memory (ROM) 142 (typically comprising flash memory as in a PDA) to store operating system and application code, and random access memory (RAM) 144 to store temporary data for applications. An external storage device 150 such as a hard drive or SD card drive is also included.

The electronic device 100 also includes one or more input devices including a key pad 152, a navigation button or a touch sensitive pad (both not separately shown). The electronic device 100 also includes a visual display screen for output. A portion or the whole of the display screen 156 may be touch sensitive and receive input from a stylus or a user's touch. In this embodiment, a portion of the display screen 156 comprises part of, or the entire touch pad 154.

Lastly, the computing device 100 also includes a communication interface 160 (and corresponding ports). Examples of a communication interface 160 include wireless communications hardware (e.g., GPRS (General Packet Radio Service), WiFi, etc.) and direct communications hardware (e.g., dial-up modem and direct LAN connection). In one embodiment of the present invention, the communication link is a serial communication port, but may also be any of a number of well-known communication standards and protocols, e.g., parallel, SCSI, Firewire (IEEE 1394), Ethernet, etc. The communication interface also provides wireless communication capability, e.g., cellular phone, Bluetooth and/or wireless LAN (e.g., IEEE 802.11).

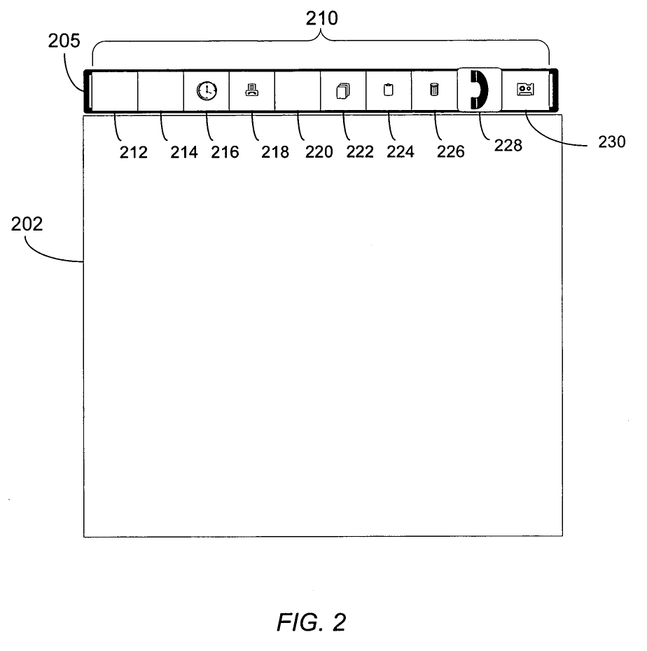

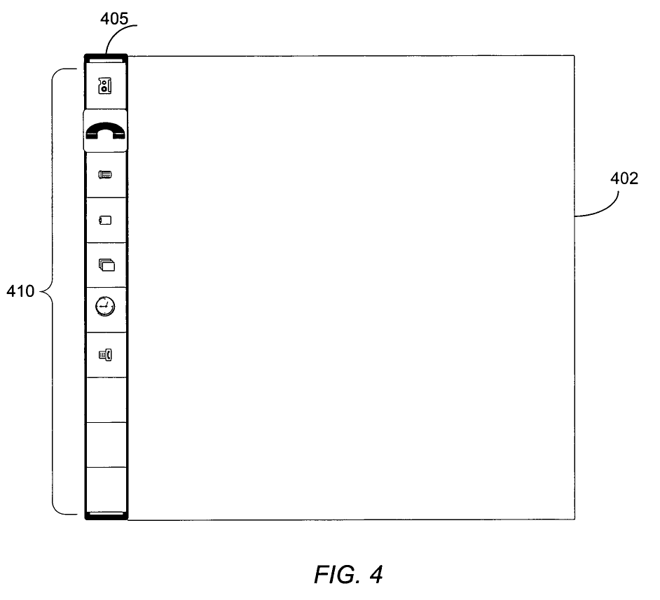

FIG. 2 is an illustration of an exemplary user interface including status gadgets in according to an embodiment of the present invention. As shown, the user interface 202 comprises a rectangular window which occupies the whole or a portion of the display screen 156. A rectangular bar, referred to as the status gadget holder 205 is situated at the top of the user interface 202. As shown in FIG. 4, which depicts an alternative embodiment of a user interface 402, the status gadget holder 205 may be arranged in other locations of the user interface 202, and may have a variety of different configurations and shapes. As depicted, the status gadget holder 405 is oriented vertically at the left side of the user interface 402. This configuration may be generated when the electronic device 100 is reoriented from a ‘portrait’ orientation to a perpendicular ‘landscape’ orientation, for example. In other embodiments, the user interface may include more than one status gadget holder (or, alternatively, the status gadget holder 205 may include a plurality of separate portions).

The status gadget holder 205 contains or encloses a set 210 of status gadgets, which are persistently displayed status notifications with respect to the current state of a running application or device component. In the depicted embodiment, the set of gadgets 210 includes ten (10) individual gadgets 212, 214, 216, 218, 220, 222, 224, 226, 228 and 230, but the status gadget holder 205 may be sized so as to hold a different number of status gadgets.

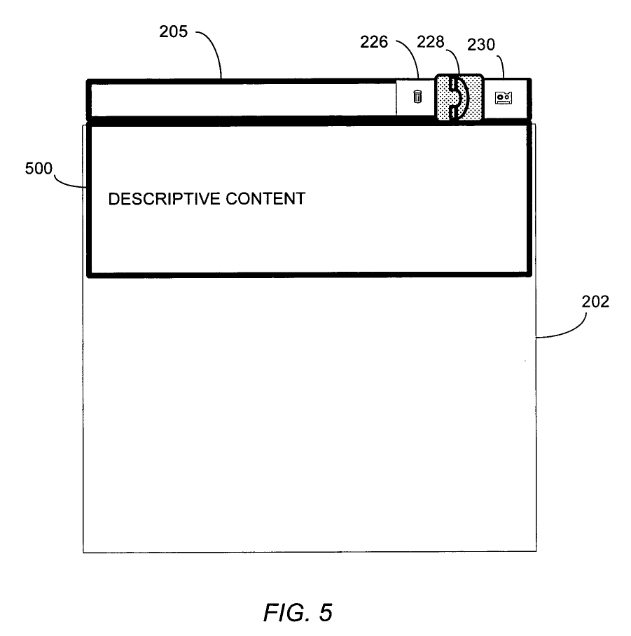

Each status gadget 212, 214 . . . 230 situated within the status gadget holder 205 has a primary output function and an input function. In term of output, each of the status gadgets 212, 214 . . . 230 comprises a status indicator, such as an icon, that provides information concerning the current status of a system/device component or an active software application. For example, status gadget 228, represented by a telephone icon, provides information regarding the status of a telephony application, such as whether an incoming call is being received or whether a voice mail has been saved. The status gadgets 212, 214 . . . 230 indicate changes of state by changing in appearance (e.g., flashing, changing color, enlarging, etc.). In some embodiments, the status gadgets 212, 214 . . . 230 indicate various states via their presence or absence in the status bar, or via animation or via audio alerts including tones or spoken messages that provide the user state information when the display is unavailable or out of sight. The status gadgets 212, 214 . . . 230 may be interactive and selectable by the user. In this manner, the user are able to use the status gadgets 212, 214, . . . 230 to activate an application and/or to acquire further information as discussed further below with respect to FIG. 5.

In addition, a user input (e.g., by touch) enables the status gadget icons 212, 214 . . . 230 to appear within the status gadget holder 205. This is advantageous because the display screen size is constrained and also because the display screen 156 may be curved. The sizes of the status gadget icons 212, 214 . . . 230 can be varied depending on the display area allocated for the user interface 202. A user may scroll through further application not currently shown on the user interface 202 may activating a button which allows applications to be unfolded, for example, by cycling through.

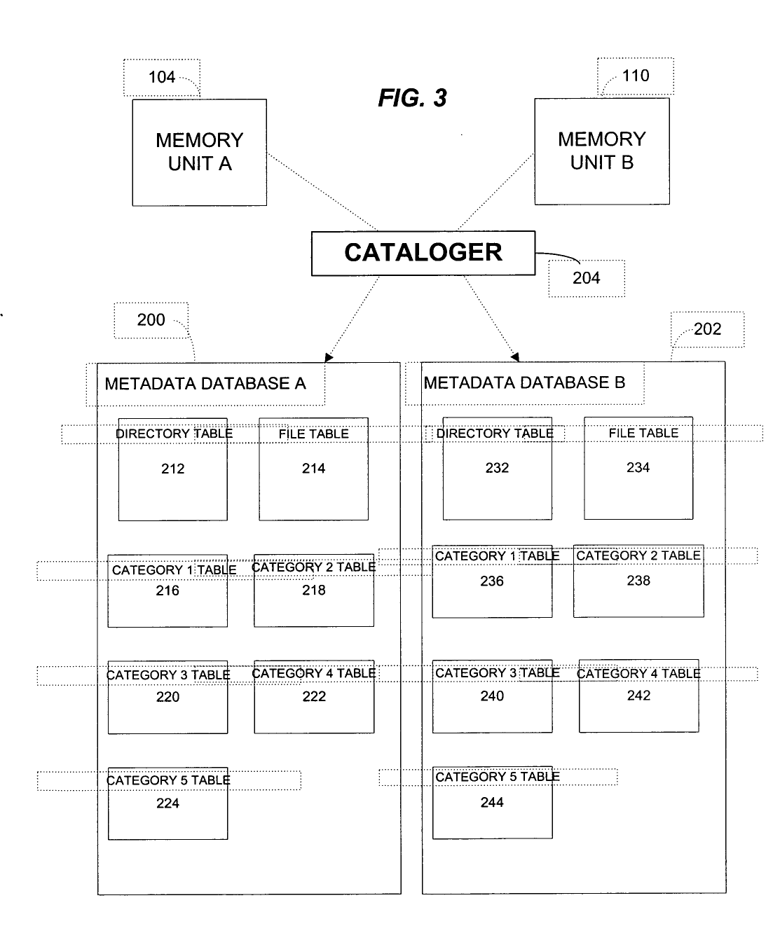

FIG. 3 is a block diagram of an exemplary system for generating and managing the user interface 202 including the status gadget holder 205 and set of status gadgets 210 according to an embodiment of the present invention. The system 300 comprises software components generated by and executed on the processor 110 of the electronic device 100.

A status manager component 302 is adapted to monitor device and application streams and to provide output to a user interface application 304 for controlling the appearance of each of the status gadgets in the set 210 displayed on the user interface 202. The status manager 302 may run as a background process (daemon).

The status manager 302 accesses status gadget code 306, which includes common libraries (e.g., Linux libraries) and program code, to install and display the status gadgets on the user interface 202. The status gadget code 306 includes code that governs the appearance of the status gadgets but also may include instructions and references to the applications and components to which the status gadgets relate. After the status gadgets have been installed, links are created so that the status manager 302 can monitor the state of the device components and software applications that correspond to the status gadgets. To receive the status information, the status manager 302 interacts with application programs interfaces (APIs) 308 which provide output outside of the context of application streams to the status manager 302. For example, in the case of a telephony application,

The status manager 302 uses the status information received from the APIs 308 to control the appearance of the status gadgets in the set 210. In one example, the status manager receives information from a schedule application that the time for a scheduled event is approaching and causes an event status gadget 216 shown as a clock to flash, change color, enlarge or change in some other way to provide an alarm notification of the upcoming event to the user.

Additionally, the status manager 302 is adapted to receive user input when the user focuses on and selects a status gadget. FIG. 5 illustrates the user interface shown in FIG. 2 with the addition of a sliplet 400 which is presented when the user focuses upon and selects a status gadget, in this case status gadget 228, which is shown shaded and enlarged due to the selection. Also, as shown, other status gadgets in the set 210 (e.g., 212, 214) may be made to disappear from view upon the selection of another of the status gadgets.

In terms of operation, users are able to navigate into the status gadget holder 205 using an input method such as five-way navigation or touch. They are also be able to navigate to the individual status gadgets of the set 210, giving them focus. Once an individual status gadget is in focus, the user can select the gadget, whereupon it may do nothing, perform a simple state change, or display a sliplet, depending upon the function of the selected status gadget.

In some embodiments, the sliplet 400 is a rectangular dialog box positioned adjacent (or attached) to and underneath the status gadget holder 205. The sliplet 400 may also be formed and positioned in other ways. The sliplet 400 includes detailed status information, interaction options that affect the application referenced by the selected, or links to navigate to the full instantiation of the referenced application.

One of the significant benefits provided by the present invention is that the opening of a status gadget and associated sliplet does not disturb the user's current context. Thus, the user interface provided according to the present invention serves the purpose of multiple windows in environments that do not use a conventional desktop-type windowing system. For example, a user may be currently using a first application while the sliplet indicates an incoming text message from another application.

The disclosed invention may include modifications to further enhance and extend the system. For instance, while status gadgets primarily display information about the electronic system or device itself (e.g. battery level) or the device's environment (e.g. cell phone signal strength), status gadgets can also be applications in their own right. Status gadgets and their arrangement, and the contents of their associated sliplets can be customized for third parties to include state and state change information as described above, to express customer-specific information tied to a customer's internet-based information, or permit users to place and use small applications from external sources (via a communication link) such as: (1) a device with Internet access could display weather information for one or more specified locations, perhaps rotating among temperature, barometric pressure, humidity, probability of precipitation, and cloud cover; (2) such a device with GPS capability could display local weather information; (3) a trader could monitor the prices of specific financial instruments; (4) a computer system administrator could monitor the status and loads of servers.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method for persistently providing at least one status notification regarding a device component or application on an electronic device having a display screen, said method comprising the steps of:
assigning a selectable status notification icon for each of the at least one status notification, each status notification icon reflecting changes in the status notification for which it is assigned;
persistently displaying the status notification icon for each of the at least one status notification on the display screen of the electronic device; and
displaying a contextual dialog when a status notification icon is selection by a user of the electronic device.

2. The method of claim 1, further comprising:
displaying all status notification icons within a status notification icon holder.

3. The method of claim 2, wherein said status notification icon holder is arranged horizontally across a top of the display screen of the electronic device.

4. The method of claim 2, wherein said status notification icon holder is arranged horizontally across a bottom of the display screen of the electronic device.

5. The method of claim 2, wherein said status notification icon holder is displayed vertically across a left side of the display screen of the electronic device.

6. The method of claim 2, wherein said status notification icon holder is displayed vertically across a right of the screen of the electronic device.

7. The method of claim 1, further comprising:
changing an appearance of one or more of the status notification icons in response to a change in the underlying application or device component.

8. The method of claim 1, further comprising the step of:
changing an appearance of one or more of the status notification icons upon activation by a user.

9. The method of claim 1, further comprising the step of:
displaying detailed status information in the contextual dialog.

10. The method of claim 8, wherein changing the appearance of one or more of the status notification icons includes at least one of changing a color, a size, and a shape of the one or more status notification icons.

11. An electronic system comprising:
display screen; and
a processor adapted to:
generate a user interface on the display screen;
execute a plurality of applications;
display a set of status gadget notification icons on the user interface, each icon presenting a status of one of the plurality of applications; and
display a contextual dialog on the user interface upon selection of one of the status gadget notification icons by the user.

12. The system of claim 11, wherein the processor is adapted to display the status gadget notifications with a status notification icon holder.

13. The method of claim 12, wherein the processor is adapted to display the status notification icon holder in a horizontal orientation across a top of the user interface.

14. The method of claim 12, wherein the processor is adapted to display the status notification icon holder in a vertical orientation across a top of the user interface.

15. The method of claim 11, wherein the processor is adapted to change the appearance of the status gadget notification icons on the user interface in response to changes in the status of the underlying plurality of applications.
